(19) United States
(12) Patent Application Publication
(10) Pub. No.: US 2017/0287020 A1
(43) Pub. Date: Oct. 5, 2017

(54) WAITING NUMBER GUIDANCE SYSTEM AND GUIDING METHOD

(71) Applicant: Seung Ku KANG, Cheonan-si, Chungcheongnam-do (KR)

(72) Inventor: Min Ki BAEK, Seoul (KR)

(73) Assignee: Seung Ku KANG, Cheonan-si, Chungcheongnam-do (KR)

(21) Appl. No.: 15/508,088

(22) PCT Filed: Aug. 31, 2015
(86) PCT No.: PCT/KR2015/009138

§ 371 Date: Mar. 1, 2017

(30) Foreign Application Priority Data
Sep. 2, 2014 (KR) 10-2014-0115924

(51) Int. Cl. G06Q 30/02; H04W 4/00; G08B 7/06; H04L 29/08

(52) U.S. Cl. CPC G06Q 30/0281; H04L 67/26; H04W 4/008; G08B 7/06

(57) ABSTRACT

Disclosed is a waiting number guidance system in which a business operator terminal provided with a near field communication (NFC) module and a client terminal provided with an NFC module are connected through a server, and when the client terminal is tagged to the business operator terminal such that the business operator terminal reads unique information of the client terminal through NFC, the business operator terminal activates one among a plurality of deactivated waiting numbers and provides the activated waiting number to the client terminal, the client terminal receives the waiting number, and the client terminal, which has received the waiting number, is tagged to the business operator terminal so as to deactivate the corresponding number in the business operator terminal, thereby completing a waiting number guidance.

### TECHNICAL FIELD

The present invention relates to a waiting number guidance system, and more specifically, to a new waiting number guidance system and a guiding method which allows a personal portable terminal to be utilized as a waiting number guidance system.

### BACKGROUND ART

Generally, in places, such as banks, government offices, cafes, etc., where a large number of people perform public tasks (hereinafter, referred to as a “public place”), sheets of paper on which a number is written (e.g., queue tickets on which a waiting number is written) are sequentially distributed to clients in the order of client arrivals in order to maintain order and quickly and smoothly process tasks, such that corresponding tasks are performed in the order of the numbers written on the paper, or an individual terminal is handed to the client and the client is called through the terminal when the client's turn has arrived. In this case, the number written on the queue ticket is displayed on an electronic display or the like installed in the place, and when the client having the queue ticket corresponding to the displayed number submits the queue ticket to a business reception counter, a task for the client is processed, or the client is called through the terminal handed to the client. However, when the client is given the queue ticket according to the above-described conventional art, the client needs to keep watching the electronic display provided in the public place to check whether the number written on the queue ticket appears on the board and should hold the terminal given in the place, and hence it is difficult for the client to move to another place or perform another task while waiting. In addition, since separate electronic devices, such as an electronic display, a vibrating bell, and the like, must be provided, there is a problem of an increase in initial installation cost. Moreover, there is a problem that the maintenance cost for supplying consumables, such as paper and ink, is relatively high because it is needed to issue the queue tickets made of paper. Further, inconvenience and cost due to storage and management may be incurred to existing users who use terminals for waiting number guidance.

### DISCLOSURE

### Technical Problem

In order to solve the aforementioned problems, the objective of the present invention is to provide a waiting number guidance system which guides a waiting number using a smartphone possessed by a client without a need of purchasing a separate waiting number guidance terminal. In addition, another objective is to provide a new waiting number guidance system which provides information about a product or service when guiding the waiting number so that the client places an order using corresponding information and is provided with the ordered product or service according to a queue number of the client.

Still another objective of the present invention is to provide a waiting number guidance system which allows a client to check his/her queue number even when the client moves to another place from a public place where the client is waiting his/her turn to be provided with a product or service.

### Technical Solution

According to one embodiment of the present invention for achieving the above-described objectives, there is provided a waiting number guidance system in which a business operator terminal provided with a near-field communication (NFC) module and a client terminal provided with an NFC module are connected through a server, wherein when the client terminal is tagged to the business operator terminal so that the business operator terminal reads unique information of the client terminal through NFC, the business operator terminal activates one among a plurality of deactivated waiting numbers and provides the activated waiting number to the client terminal, the client terminal receives the waiting number, and the client terminal, which has received the waiting number, is tagged to the business operator terminal so as to deactivate the corresponding number in the business operator terminal to complete waiting number guidance.

The business operator terminal may provide the waiting number to the client terminal using any one manner among a text message, a vibration alarm, and a push notification.

When a turn of the client terminal which has received the waiting number arrives, an alarm message indicating that a client's turn has come may be transmitted to the client terminal.

When the waiting number is activated and provided to the client terminal, information about a product or service provided by a business operator may also be provided to the client terminal.

The client terminal may receive the activated waiting number and order the product or service provided by the business operator.

When a menu item ordered through the client terminal is ready, the business operator terminal may provide the client terminal with an alarm message indicating that the order is completed.

The alarm message may include a text message, a vibration alarm, or a push notification to be provided to the client terminal through the server.

A message instructing to tag the client terminal to the business operator terminal may be transmitted through the alarm message.

After the ordering of the client terminal is completed, the server may accumulate points for the client terminal corresponding to the order of the client terminal.

According to another embodiment of the present invention, there is provided a method of guiding a waiting number including: reading unique information of a client terminal through near-field communication (NFC) by tagging the client terminal to a business operator terminal; activating, by the business operator terminal, one among a plurality of waiting numbers and providing the waiting number to the client terminal; and receiving, by the client terminal, the waiting number provided by the business operator terminal.

The method may further include transmitting an alarm message indicating that a client's turn has come when a turn of the client terminal which has received the waiting number has arrived.

The method may further include: providing information about a product or service provided by a business operator to the client terminal when the waiting number is provided to the client terminal; receiving, by the client terminal, the activated waiting number and ordering the product or service from menu information including the information about the product or service provided through the business operator terminal; providing, by the business operator terminal, an alarm message, which indicates that the ordered product or service is ready to be provided, to the client terminal when the product or service ordered through the client terminal is ready; and tagging the client terminal, which has received the alarm message, to the business operator terminal and completing waiting number guidance.

The method may further include deactivating the waiting number corresponding to the client terminal in the business operator terminal when the waiting number guidance through the client terminal is completed.

The alarm message may include a text message, a vibration alarm, or a push notification to be provided to the client terminal through the server.

A message instructing to tag the client terminal to the business operator terminal may be transmitted by being included in the alarm message.

### Advantageous Effects

According to a waiting number guidance system according to the embodiments of the present invention, a product provided at a store is ordered or the turn to be provided with the service is instructed through a client terminal using near-field communication, so that it is possible to minimize costs required for constructing the waiting number guidance system.

In addition, since the client's queue number is informed using a smartphone possessed by the client, the client can be provided with a service guidance according his/her queue number even when the client moves to another place while waiting his/her turn.

Moreover, since the client is informed of a waiting number through a personal portable terminal, such as a smart phone, possessed by the client, it is possible to minimize costs for consumables, such as paper or ink.

Furthermore, since the waiting number is informed through the personal portable terminal, such as a smartphone, possessed by the client, a business operator does not need to purchase a separate waiting number terminal. Therefore, it is possible to minimize a cost burden on the business operator for a waiting number guidance.

### DESCRIPTION OF DRAWINGS

These drawings are provided to be referred to in describing exemplary embodiments of the present invention, and hence the technical ideas of the present invention should not be construed as being limited to the accompanying drawings.

FIG. 1 is a conceptual diagram illustrating a configuration of a waiting number guidance system according to an embodiment of the present invention.

FIG. 2 is a diagram illustrating a membership subscription screen of a waiting number guidance app of the waiting number guidance system according to the embodiment of the present invention.

FIG. 3 is a diagram illustrating waiting numbers in the waiting number guidance app of the waiting number guidance system according to the embodiment of the present invention.

FIG. 4 is a diagram illustrating a screen for configuring menu items offered at a store in the waiting number guidance app of the waiting number guidance system according to the embodiment of the present invention.

FIG. 5 is a diagram illustrating a screen after completion of ordering using the waiting number guidance app of the waiting number guidance system according to the embodiment of the present invention.

FIG. 6 is a diagram illustrating an alarm message of the waiting number guidance app of the waiting number guidance system according to the embodiment of the present invention.

FIG. 7 is a diagram illustrating a screen after using the waiting number guidance app of the waiting number guidance system according the embodiment of the present invention.

FIG. 8 is a flowchart illustrating a method of guiding a waiting number according to an embodiment of the present invention.

### BEST MODE OF THE INVENTION

According to the present invention, a waiting number guidance system in which a business operator terminal provided with a near-field communication (NFC) module and a client terminal provided with an NFC module are connected to each other through a server is characterized in that when the client terminal is tagged to the business operator terminal so that the business operator terminal reads unique information of the client terminal through NFC, the business operator terminal activates one among a plurality of deactivated waiting numbers and provides the activated waiting number to the client terminal, the client terminal receives the waiting number, and the client terminal, which has received the waiting number, is tagged to the business operator terminal so as to deactivate the corresponding number in the business operator terminal, thereby completing waiting number guidance.

### MODES OF THE INVENTION

Hereinafter, the present invention will be described more fully with reference to the accompanying drawings, in which exemplary embodiments of the invention are shown. However, as those skilled in the art would realize, the described embodiments may be modified in various different ways, all without departing from the sprit or scope of the present invention. Irrelevant details have been omitted from the drawings for increased clarity and conciseness, and similar parts are indicated by similar reference numerals throughout the detailed description. The relative size and thicknesses of elements may be arbitrarily set for convenience of illustration, and hence the present invention should not be construed as being limited to the specific form illustrated herein and the thicknesses of parts and regions are exaggerated for clarity of illustration.

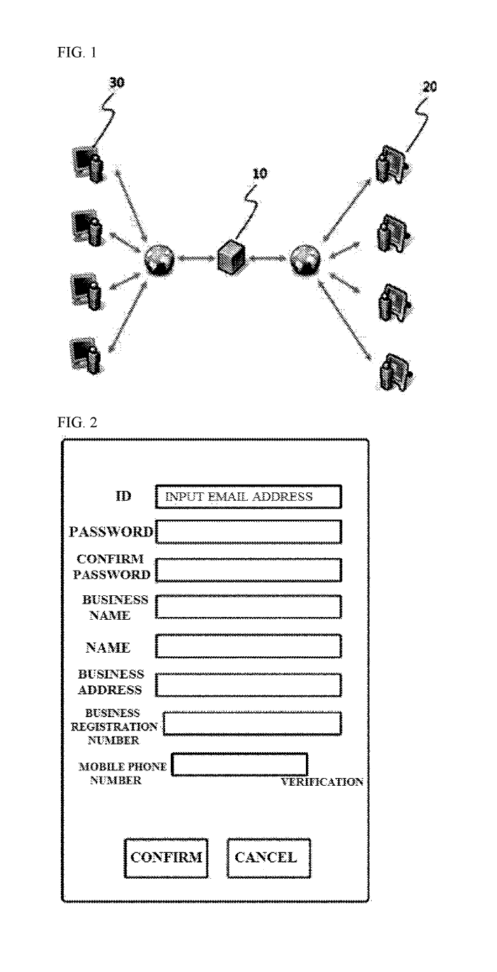

Hereinafter, a waiting number guidance system according to an embodiment of the present invention will be described in detail with reference to the accompanying drawings. FIG. 1 is a conceptual diagram illustrating a configuration of a waiting number guidance system according to an embodiment of the present invention.

As shown in FIG. 1, in the waiting number guidance system according to the embodiment of the present invention, business operator terminals 20 and client terminals 30 are connected to each other through a sever 10. In this case, the business operator terminals 20 and the client terminals 30 may be personal portable terminals such as smartphones. The business operator terminal 20 and the client terminal 30 each may be provided with a near field communication (NFC) module allowing for near-field wireless communication between the business operator terminal 20 and the client terminal 30.

When the client terminal 30 is tagged to the business operator terminal 20 so that the business operator terminal 20 reads unique information of the client terminal (e.g., phone number or serial number of the client terminal) through NFC, the business operator terminal 20 activates one among a plurality of deactivated waiting numbers and provides the activated waiting number to the client terminal 30. Then, the client terminal 30 receives the waiting number provided by the business operator terminal 20. In addition, the client terminal 30, which has received the waiting number, is tagged to the business operator terminal 20 so as to deactivate the corresponding number in the business operator terminal 20, thereby completing waiting number guidance. At this time, the process of waiting number guidance through the business operator terminal 20 and the client terminal 30 may be implemented through a smartphone application (hereinafter, referred to as a “waiting number guidance app”). The waiting number guidance app refers to an application program which is designed to guide a waiting number provided by the business operator terminal 20 through the client terminal 30.

When an unique number of the client terminal 30 is read through NFC between the client terminal 30 and the business operator terminal 20, one among a plurality of deactivated waiting numbers is activated through the waiting number guidance app and is provided to the client terminal.

In this case, reading the unique number of the client terminal through NFC between the client terminal 30 and the business operator terminal 20 means that the client terminal 30 reads information of the business operator terminal 20 (or vice versa) through the NFC modules between the client terminal 30 and the business operator terminal 20. A method of reading information through NFC is general in the technical field to which the present invention pertains and a detailed description thereof will be omitted.

When a turn of the client terminal 30 which has been tagged to the business operator terminal 20 arrives among the waiting clients, a business operator sends an alarm message to notify the client terminal 30 that the client's turn has arrived. In this case, the alarm message may include a text message, a vibration alarm, or a push notification, which is provided to the client terminal 30 through the server 10.

Thereafter, when the client terminal 30, which has received the alarm message, is tagged to the business operator terminal 20, the business operator terminal 20 reads the unique information of the client terminal through NFC, and a waiting number guidance process is completed.

As such, when the client terminal 30 is tagged to the business operator terminal 20 once, the business operator terminal 20 reads the unique number of the client terminal 30 and provides a waiting number to the client terminal 30.

In addition, the client terminal 30 receives the alarm message notifying of its turn, and when the client terminal 30 is tagged to the business operator terminal 20 for a second time, the business operator terminal 20 reads the unique number of the client terminal 30, thereby completing the waiting number guidance process for the pertinent client terminal 30.

Meanwhile, when the business operator terminal 20 activates and provides the waiting number to the client terminal 30, the business operator terminal 20 may also provide information about products or services provided by the business operator to the client terminal 30.

In addition, the client terminal 30 may place an order for the product or service provided by the business operator through the business operator terminal 20.

For example, the client willing to order the product or service selects the activated waiting number from the waiting number guidance app in the client terminal 30 to select from menu items provided by the business operator terminal 20. That is, when the client selects the activated waiting number in the client terminal 30, the menu items provided by the business operator terminal 20 are displayed on the client terminal 30 and the client selects a desired menu item from the displayed menu items, thereby placing an order for the product or service provided by the business operator through the client terminal 30. Also, when the menu item ordered through the client terminal 30 is completed, a user provides an alarm message indicating that the order is completed in the client terminal 30 through the server 10 using the business operator terminal 20.

When the client terminal 30, which has received the alarm message, is tagged to the business operator terminal 20, the business operator terminal 20 reads the unique information of the client terminal 30, thereby completing the order through the client terminal 30. In addition, the waiting number corresponding to the turn of the client terminal 30 is deactivated. In this case, the client terminal 30 may pay for the ordered product using electronic money, micropayments through a smartphone, or the like.

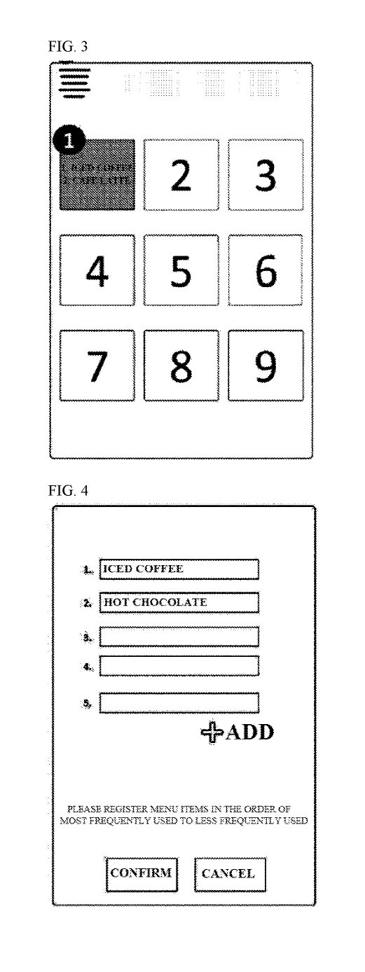

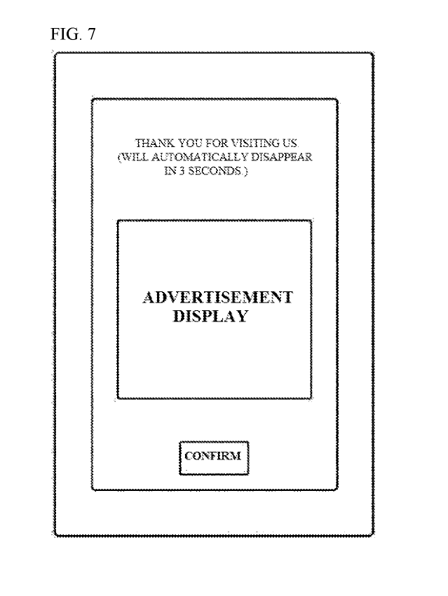

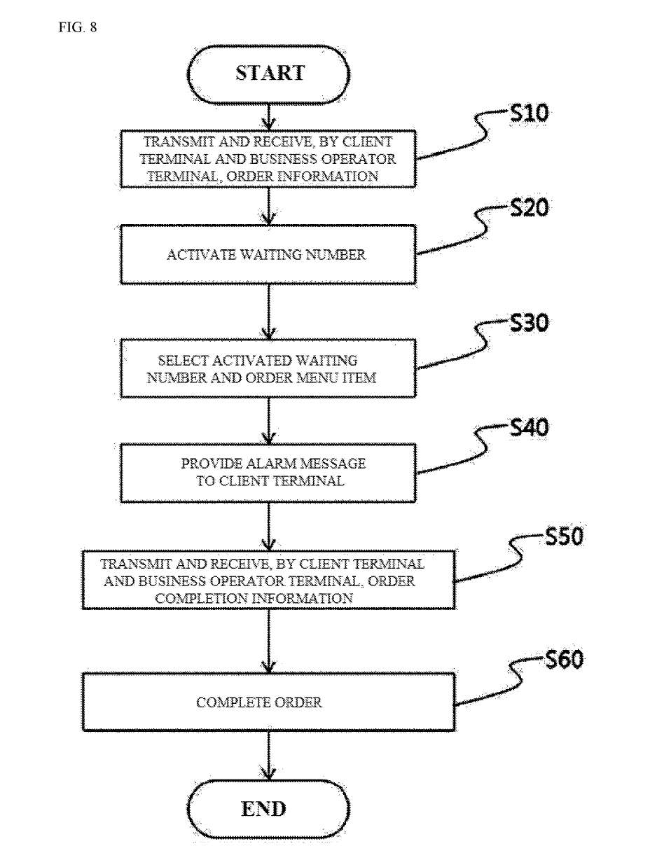

Hereinafter, the waiting number guidance system according to the above-described embodiment of the present invention will be described with reference to FIGS. 2 and 7. In the embodiment of the present invention, an example in which a client visiting a café orders a menu item will be described.

FIG. 2 is a diagram illustrating a membership subscription screen of a waiting number guidance app of the waiting number guidance system according to the embodiment of the present invention.

As shown in FIG. 2, when a client has not joined the waiting number guidance app, the client registers as a member through a member registration page and then executes the waiting number guidance app.

When the client tags the client terminal 30 to the business operator terminal 20 (that is, when unique information of the client terminal 30 is read through NFC between the client terminal 30 and the business operator terminal 20), the waiting number guidance app is executed in the client terminal 30.

FIG. 3 is a diagram illustrating waiting numbers in the waiting number guidance app of the waiting number guidance system according to the embodiment of the present invention.

As shown in FIG. 3, when the waiting number guidance app is executed, a waiting number that corresponds to the turn of the client terminal 30 is activated through the waiting number guidance app according to the turn of the client terminal 30 which is waiting in the store. In addition, the client may order a menu item provided by the business operator terminal 20 by clicking waiting number “1” activated in the client terminal 30.

FIG. 4 is a diagram illustrating a screen for configuring menu items offered at a store in the waiting number guidance app of the waiting number guidance system according to the embodiment of the present invention.

As shown in FIG. 4, when a client clicks waiting number “1” activated in the client terminal 30, an order screen is displayed. The client orders a menu item (or a product) to be sold or provided at the store through the order screen. FIG. 4 shows that the client has ordered “iced coffee” and “hot chocolate” through the client terminal 30.

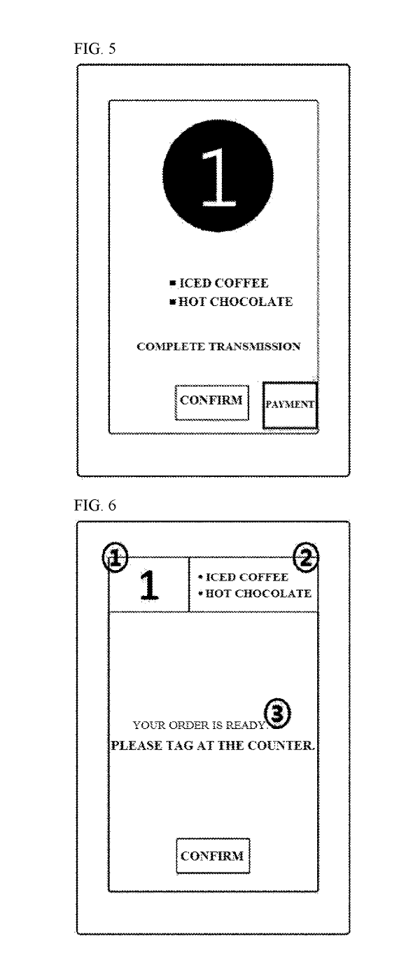

FIG. 5 is a diagram illustrating a screen after completion of ordering using the waiting number guidance app of the waiting number guidance system according to the embodiment of the present invention.

When a product to be sold at the store is ordered and a confirmation button is clicked in the screen of FIG. 4, details of the product ordered by the client through the client terminal 30 are transmitted to the business operator terminal 20, the order is completed in the client terminal 30 and a message confirming that the order has been transmitted to the business operator terminal 20 is displayed on the client terminal 30, as shown in FIG. 5. FIG. 5 shows that the details of ordering “iced coffee” and “hot chocolate” are successfully transmitted to the business operator terminal 20. In this case, the products ordered by the client through the client terminal 30 may be paid for using electronic money, micropayments through a smartphone, or the like.

FIG. 6 is a diagram illustrating an alarm message of the waiting number guidance app of the waiting number guidance system according to the embodiment of the present invention. When a client has ordered “iced coffee” and “hot chocolate” through the client terminal 30 and the products ordered by the client are ready, an alarm message is transmitted to the client through the business operator terminal 20. That is, as shown in FIG. 6, text indicating that the iced coffee and hot chocolate ordered by the client are ready to be picked up is transmitted to the client terminal 30. Then, a message instructing the client to tag the client terminal 30 to the business operator terminal 20 is also transmitted. In this case, the alarm message may include a text message, a vibration alarm, or a push notification, or a combination thereof.

FIG. 7 is a diagram illustrating a screen after using the waiting number guidance app of the waiting number guidance system according the embodiment of the present invention.

As shown in FIG. 7, when a client tags the client terminal 30 to the business operator terminal 20 in order to pick up the ordered product (when the unique information of the client terminal 30 is read through NFC between the client terminal 30 and the business operator terminal 20), the ordering process through the client terminal 30 is completed, and a use termination message is displayed on the client terminal 30. At this time, advertisement text may also be displayed on the client terminal 30.

Hereinafter, a method of guiding a waiting number according to the embodiment of the present invention will be described in detail with reference to the accompanying drawings.

FIG. 8 is a flowchart illustrating a method of guiding a waiting number according to an embodiment of the present invention.

Referring to FIG. 8, first, the client terminal 30 is tagged to the business operator terminal 20 (that is, unique information of the client terminal 30 is read through NFC modules between the client terminal 30 and the business operator terminal 20) (S10).

Thereafter, the business operator terminal 20 activates one among a plurality of deactivated waiting numbers and provides the activated waiting number to the client terminal, and the client terminal 30 receives the activated waiting number (S20).

When the turn of the client terminal, which has been tagged to the business operator terminal 20, arrives, the business operator terminal 20 sends an alarm message to inform that the client's turn has arrived (S40). At this time, a message instructing to tag the client terminal 30 to the business operator terminal 20 may be transmitted through the alarm message. In addition, when the client terminal 30, which has received the alarm message, is tagged to the business operator terminal 20, the business operator terminal 20 reads the unique information of the business operator terminal through NFC (S50), and the waiting number corresponding to the turn of the client terminal 30 is deactivated. Accordingly, a waiting number guidance process is completed (S60).

Meanwhile, when a product or service provided by a business operator is ordered through the client terminal 30, information about products or services provided by the business operator may also be provided to the client terminal 30 when the waiting number is provided. In addition, the client terminal 30 receives the activated waiting number and orders the product or service from menu information including the information about the products or services provided through the business operator (S30). When the activated waiting number is selected through the client terminal 30, a list of the products or services provided by the business operator terminal 20 is displayed on the client terminal 30, and the client selects and orders the desired product or service from the displayed list. The order information is transmitted to the business operator terminal 20. The business operator terminal 20 provides the client terminal 30 with an alarm message indicating that the order is completed (S40). The alarm message may include a text message, a vibration alarm, or a push notification to be provided to the client terminal 30 through the server 10. In addition, a message instructing to tag the client terminal 30 to the business operator terminal 20 may be transmitted through the alarm message.

Finally, when the client terminal 30 is tagged to the business operator terminal 20 (when unique information of the client terminal is read through NFC modules between the client terminal 30 and the business operator terminal 20) (S50), ordering of the product or service through the client terminal 30 is completed (S60), and the waiting number corresponding to the turn of the client terminal 30 is deactivated.

While the present invention has been described in connection with what is presently considered to be practical exemplary embodiments, it should be understood that the present invention is not limited to the disclosed embodiments, but, on the contrary, is intended to cover various modifications and equivalent arrangements included within the spirit and scope of the appended claims.

### INDUSTRIAL APPLICABILITY

The present invention relates to a waiting number guidance system and enables a personal portable terminal to be utilized as a waiting number guidance system.

1. A waiting number guidance system in which a business operator terminal provided with a near-field communication (NFC) module and a client terminal provided with an NFC module are connected through a server, wherein:
when the client terminal is tagged to the business operator terminal so that the business operator terminal reads unique information of the client terminal through NFC, the business operator terminal activates one among a plurality of deactivated waiting numbers and provides the activated waiting number to the client terminal, the client terminal receives the waiting number; and
the client terminal, which has received the waiting number, is tagged to the business operator terminal so as to deactivate the corresponding number in the business operator terminal to complete waiting number guidance.

2. The waiting number guidance system of claim 1, wherein the business operator terminal provides the waiting number to the client terminal using any one manner among a text message, a vibration alarm, and a push notification.

3. The waiting number guidance system of claim 1, wherein, when a turn of the client terminal which has received the waiting number arrives, an alarm message indicating that a client's turn has come is transmitted to the client terminal.

4. The waiting number guidance system of claim 1, wherein, when the waiting number is activated and provided to the client terminal, information about a product or service provided by a business operator is also provided to the client terminal.

5. The waiting number guidance system of claim 4, wherein the client terminal receives the activated waiting number and orders the product or service provided by the business operator.

6. The waiting number guidance system of claim 5, wherein, when a menu item ordered through the client terminal is ready, the business operator terminal provides the client terminal with an alarm message indicating that the order is completed.

7. The waiting number guidance system of claim 3, wherein the alarm message includes a text message, a vibration alarm, or a push notification to be provided to the client terminal through the server.

8. The waiting number guidance system of claim 3, wherein a message instructing to tag the client terminal to the business operator terminal is transmitted through the alarm message.

9. The waiting number guidance system of claim 1, wherein, after the ordering of the client terminal is completed, the server accumulates points for the client terminal corresponding to the order of the client terminal.

10. A method of guiding a waiting number comprising:
reading unique information of a client terminal through near-field communication (NFC) by tagging the client terminal to a business operator terminal;
activating, by the business operator terminal, one among a plurality of waiting numbers and providing the waiting number to the client terminal; and
receiving, by the client terminal, the waiting number provided by the business operator terminal.

11. The method of claim 10, further comprising transmitting an alarm message indicating that a client's turn has come when a turn of the client terminal which has received the waiting number has arrived.

12. The method of claim 10, further comprising:
providing information about a product or service provided by a business operator to the client terminal when the waiting number is provided to the client terminal;
receiving, by the client terminal, the activated waiting number and ordering the product or service by using menu information including the information about the product or service provided through the business operator terminal;
providing, by the business operator terminal, an alarm message, which indicates that the ordered product or service is ready to be provided, to the client terminal when the product or service ordered through the client terminal is ready; and
tagging the client terminal, which has received the alarm message, to the business operator terminal and completing waiting number guidance.

13. The method of claim 10, further comprising deactivating the waiting number corresponding to the client terminal in the business operator terminal when the waiting number guidance through the client terminal is completed.

14. The method of claim 11, wherein the alarm message includes a text message, a vibration alarm, or a push notification to be provided to the client terminal through the server.

15. The method of claim 11, wherein a message instructing to tag the client terminal to the business operator terminal is transmitted by being included in the alarm message.

16. The waiting number guidance system of claim 6, wherein the alarm message includes a text message, a vibration alarm, or a push notification to be provided to the client terminal through the server.

17. The waiting number guidance system of claim 6, wherein a message instructing to tag the client terminal to the business operator terminal is transmitted through the alarm message.

18. The method of claim 12, further comprising deactivating the waiting number corresponding to the client terminal in the business operator terminal when the waiting number guidance through the client terminal is completed.

19. The method of claim 12, wherein the alarm message includes a text message, a vibration alarm, or a push notification to be provided to the client terminal through the server.

20. The method of claim 12, wherein a message instructing to tag the client terminal to the business operator terminal is transmitted by being included in the alarm message.
